(19) United States
(12) Patent Application Publication
(10) Pub. No.: US 2007/0036347 A1
(43) Pub. Date: Feb. 15, 2007

(54) Mobile Telephone with Ringer Mute

(76) Inventor: Mordechai Teicher, Hod-Hasharon (IL)

Correspondence Address: MR. MORDECHAI TEICHER;CREATIVE INPUTS LTD., PO BOX 991, KFAR-SABA, ISRAEL, 44109, IL

(21) Appl. No.: 11/161,512

(22) Filed: Aug. 6, 2005

(51) Int. Cl. H04M 3/00

(52) U.S. Cl. 379/418; 455/575.1

(57) ABSTRACT

A cellular telephone includes a motion sensor to detect when the telephone is moved. When an unwanted audio ring sounds in a public event, it can be muted by merely moving the phone, or moving an article accommodating the phone.

### BACKGROUND OF THE INVENTION

The present invention relates to mobile telephones, and in particular to mobile handsets having an audio ringer.

### DESCRIPTION OF RELATED ART

People attending a concert, lecture or church are often distracted and irritated when a cellular telephone rings. In many such cases, the telephone owner has inadvertently left the telephone turned on in his or her briefcase, handbag or coat pocket, and is desperately fumbling for the phone for stopping the annoying sound under the hostile watches of the audience. It could be advantageous to help such innocent and embarrassed telephone owner by minimizing the time needed for silencing the unwanted ring. U.S. Pat. Nos. 6,002,763, 6,122,366, 6,438,385, 6,549,792, 6,675,002; US patent application publication 2005/0128062A1; and PCT application publication WO01/56256 are believed to represent pertinent background art and are incorporated herein by reference as if set forth herein.

### BRIEF SUMMARY OF THE INVENTION

The present invention seeks to help the user of a cellular telephone in silencing an unwanted audio ring, without requiring that the telephone is physically reached and without requiring any external instrumentation. This goal is accomplished by including a motion sensor (e.g. accelerometer) within the telephone, and muting the audio ring upon sensing that a predetermined level of motion has been reached. To avoid undesirable mutes upon walking or jogging, the motion level before the ring is preferably also monitored and taken into account as a baseline, so that only an abrupt motion after a motionless period is effecting the muting.

### BRIEF DESCRIPTION OF SEVERAL VIEWS OF THE DRAWINGS

The present invention will be understood and appreciated more fully from the following detailed description, taken in conjunction with the drawings in which:

FIG. 1 is a simplified block diagram describing a mobile telephone according to a preferred embodiment of the present invention.

FIG. 2 is a simplified flowchart describing the operation of the embodiment of FIG. 1.

### DETAILED DESCRIPTION OF THE INVENTION

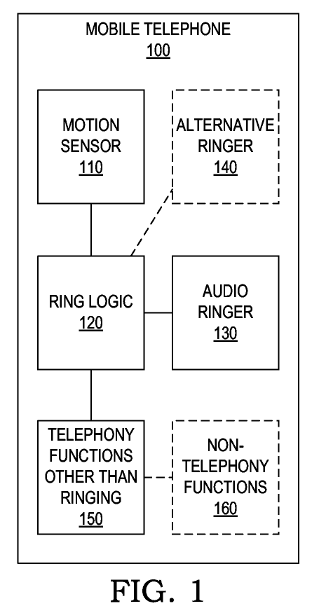

Reference is made to FIG. 1, which schematically describes mobile telephone 100 constructed according to a preferred embodiment of the present invention. Telephony functions other than ringing 150 include all the components and functionalities customary in cellular telephony, except ringing functionality that is modified according to the present invention. Optional non-telephony functions 160 include additional components and functionalities such as camera, music player, palmtop computer, etc. Ring logic 120 includes the circuits and firmware for activating audio ringer 130 and possibly also optional alternative ringer 140. Audio ringer 130 sounds a customary audible ring tone. Optional alternative ringer 140 is a conventional component that calls the attention of the user without annoying the surrounding audience, e.g. by generating a vibration or light. Motion sensor 110 is a component that detects and/or measures the motion of mobile telephone 100; it can be as simple as a common mercury switch that just detects when mobile telephone 100 is shaken, or be a sophisticated accelerometer. The term “motion sensor” used herein relates to sensing the motion of the body that incorporates the sensor and must not be confused with motion sensors used in alarm systems to detect objects moving in the proximity of and relatively to the sensor.

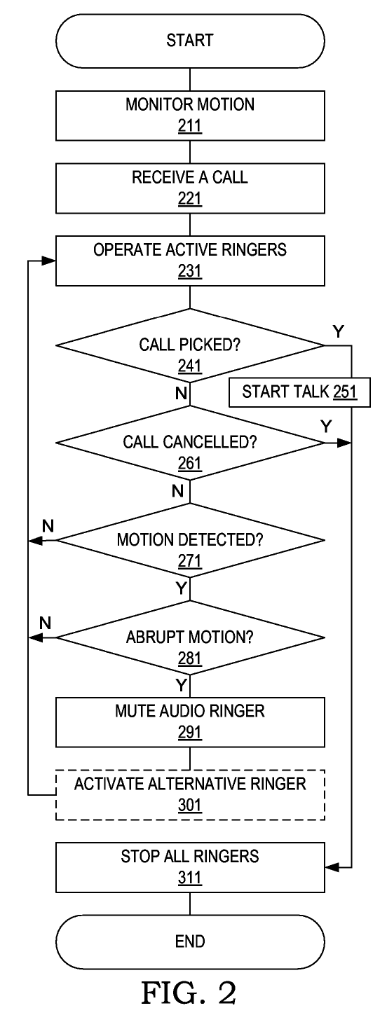

Ring logic 120 operates conventionally when a call is received, i.e. it activates audio ringer 130 and/or alternative ringer 140 according to the conventional settings previously made by the user. However, if mobile telephone 100 is moved prior to answering the call, as detected by motion sensor 110, then ring logic 120 mutes audio ringer 130, as described below with respect to FIG. 2. Thus, even if mobile telephone 100 is buried deeply within a briefcase, a handbag or a coat pocket, picking that object provides sufficient motion to mobile telephone 100, which is detected by motion sensor 110 for driving ring logic 120 to mute audio ringer 130.

FIG. 2 describes the operation of mobile telephone 100 of FIG. 1. In a step 211, ring logic 120 continually monitors readouts of motion sensor 110 to determine whether mobile telephone 100 has reached a predefined motionless period. This monitoring is preferably used in order to detect that the mute operation of the present invention is activated when the telephone has been at rest prior to receiving the call, and not while jogging or walking, where muting upon detecting motion could be undesirable. As an example, two minutes with no motion can be considered as a sufficient rest period to enable the mute operation. In a step 221 mobile telephone 100 receives, through telephony functions other than ringing 150, a conventional electromagnetic call signal through the cellular network (not shown). As a result, in a step 231 ring logic 120 operates the active ringers from audio ringer 130 and alternative ringer 140. It will be appreciated that many cellular telephones allow the user to determine what ringers will be active upon receiving a call. It will be noted that in the case that audio ringer 130 has already been turned off by the user, the present invention, as well as some steps of FIG. 2, become redundant, and therefore, for clarity, it is presumed that step 231, when following step 221, finds audio ringer 130 active. In a step 241 ring logic 120 checks whether the user has picked the call, as reported by telephony functions other than ringing 150. If the answer is positive, then in a step 251 telephony functions other than ringing 150 allow the user to start talking, while in a step 311 ring logic 120 stops all ringers conventionally. If the call is not picked in step 241, then in a step 261 telephony functions other than ringing 150 check whether the call has been cancelled by the caller or cut-off by the cellular network, which causes step 311 to stop all ringers conventionally. If the incoming call signal is still active (i.e. not stopped by either step 241 or step 261), then in a step 271, ring logic 120 checks with motion sensor 110 whether a motion has been detected, and if not, the active ringers continue their operation in step 231. If a motion has been detected in step 271, then in a step 281 the motion is checked to determine whether it is abrupt; this step is devised to distinguish between modes of operation such as walking and jogging, wherein the mute functionality of the present invention is undesirable, and the typical pattern of a concert, a lecture or a church, where the motion caused by one picking his or her briefcase, handbag or coat upon hearing the ring will highly deviate from the lack of motion prior to that event; here the information recorded by ring logic 120 in step 211 is preferably used as a reference; for example, if two motionless minutes have been counted by step 211, then a motion detected by step 271 will be considered abrupt by step 281. If in step 281, the motion detected in step 271 is found not abrupt (e.g. a natural motion during jogging) then in step 231 the ringers continue their operation. If in step 281 the motion has been found abrupt (as is the typical case in a concert), then a step 291 mutes the audio ringer (if it was active) by silencing it and temporarily setting it to be inactive. In an optional step 301, alternative ringer 140 is operated and becomes temporarily active in the telephone setting (if it has not been already active), to assist the user in finding the telephone in the briefcase, handbag or coat pocket without annoying others. The procedure then goes back to step 231, this time with the audio ringer temporarily disabled, and the loop of steps 231-301 continues until the call is either picked in step 241 or cancelled in step 261, but this time with audio ringer 130 silenced. As noted above, steps 271-301 become redundant when audio ringer 130 is inactive, and can be skipped. Also, the ringer settings that are tentatively changed by steps 291-301 remain valid for the current call and are preferably reset to the user presets when the call ends.

It will be noted that monitoring the motion is step 211 is preferable and helpful but not mandatory for the operation of the present invention. Identifying that a motion is abrupt in step 281 can be alternatively based on signal analysis, made by ring logic 120 based on readouts of an accelerometer that serves as motion sensor 110, to identify that mobile telephone 100 is intentionally shaken and not accidentally or naturally moved. In this embodiment, the user is then preferably instructed to fiercely shake the article accommodating his ringing phone, in order to mute the ringer.

It will be also noted that while detecting an abrupt motion in step 281 mutes audio ringer 130, the call is preferably not picked up by step 281, and waits until the user picks it up normally is step 241. This prevents losing important calls while fumbling for the phone in a loaded briefcase, yet silencing the disturbing ring sound while the phone is still hiding inside the briefcase.

It will be appreciated that the present invention allows a user attending a public event to silence an annoying ring by simply picking his phone or any article (such as a briefcase, handbag or coat) accommodating the phone. Natural motion during walking or jogging will not mute the ring since the motion detected after the ring will not be considered abrupt by the ring logic in step 281.

In another preferred embodiment, which requires more user attention and awareness, the telephone can be set by the user, when entering a public event, to become sensitive to and muted by any motion, and reset by the user to normal mode (i.e. insensitive to motion) upon exiting the event. In this embodiment, step 281 will be skipped and a positive outcome of step 271 (i.e. motion is detected) will lead directly to muting the ringer in step 291.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art

What is claimed is:

1. A mobile telephone comprising:
a motion sensor operative to detect motion of the mobile telephone;
an audio ringer; and
a ring logic, operationally connected to said motion sensor and said audio ringer, operative to mute said audio ringer upon receiving a signal from said motion sensor.

2. The mobile telephone of claim 1, also including an alternative ringer operationally connected to said ring logic, said ring logic is further operative to activate said alternative ringer upon effecting said mute.

3. A method for operating a mobile telephone, comprising:
receiving an electromagnetic call signal;
operating an audio ringer;
detecting whether the mobile telephone is in motion;
muting said audio ringer if said detecting is positive.

4. The method of claim 3, wherein said receiving a call signal is preceded by monitoring a prior motion of the mobile telephone, and said detecting is made relatively to said prior motion.

5. The method of claim 3, further comprising activating an alternative ringer upon said muting.
